(19) United States
(12) Patent Application Publication
(10) Pub. No.: US 2026/0222115 A1
(43) Pub. Date: Jul. 30, 2026

(54) NON-LINEARITIES MITIGATION INTERLEAVER FOR FORWARD ERROR CORRECTION ENCODER WITH PROBABILISTIC CONSTELLATION SHAPING

(71) Applicant: Marvell Asia Pte Ltd, Singapore (SG)

(72) Inventors: Ramiro Rogelio Lopez, Cordoba (AR); Mario Alejandro Castrillon, Cordoba (AR); Damian Alfonso Morero, Cordoba (AR); Luis Alberto Donet, Cordoba (AR); Martin Carlos Asinari, Cordoba (AR)

(73) Assignee: Marvell Asia Pte Ltd, Singapore (SG)

(21) Appl. No.: 19/459,322

(22) Filed: Jan. 26, 2026

Related U.S. Application Data
(60) Provisional application No. 63/751,758, filed on Jan. 30, 2025.

(51) Int. Cl. H04L 1/00; H04L 27/34

(52) U.S. Cl. CPC H04L 1/0071; H04L 27/3405

(57) ABSTRACT

A system and method are provided for mitigating non-linear effects in high-speed optical communication systems using quadrature amplitude modulation (QAM) with probabilistic constellation shaping (PCS) and forward error correction (FEC). The transmitter includes a non-linear mitigation (NLM) interleaver, which permutes amplitude bits after FEC encoding to reduce energy variance in the transmitted signal. This targeted interleaving minimizes the impact of optical channel non-linearities, supporting various interleaving modes and advanced FEC schemes. At the receiver, a corresponding NLM de-interleaver restores the original bit order, enabling robust error correction and improved transmission performance.

### PRIORITY APPLICATION

This patent application claims priority to and/or receives benefit from U.S. Provisional Application No. 63/751,758, titled, “Non-Linearities Mitigation Interleaver for Probabilistic Constellation Shaping and Forward Error Correction in Reverse Concatenation Schemas”, filed on Jan. 30, 2025. The U.S. Provisional Application is hereby incorporated by reference in its entirety.

### BACKGROUND

High-speed, high-bandwidth communication systems are integral to modern computing and networking applications. These systems are designed to facilitate efficient and reliable data transmission over various media, including optical fibers, copper cables, and wireless channels. Forward error correction (FEC) schemes are often used in high-speed coherent optical communication systems. Probabilistic constellation shaping (PCS) techniques are being used in conjunction with FEC schemes to increase channel capacity.

### BRIEF DESCRIPTION OF THE DRAWINGS

Embodiments will be readily understood by the following detailed description in conjunction with the accompanying drawings. To facilitate this description, like reference numerals designate like structural elements. Embodiments are illustrated by way of example, and not by way of limitation, in the figures of the accompanying drawings.

FIG. 1 illustrates a pair of block diagrams for encoding and decoding signals using FEC and distribution matching.

FIG. 2 illustrates a pair of block diagrams for encoding and decoding signals using FEC and distribution matching with additional interleaving and de-interleaving steps.

FIG. 3 illustrates a pair of block diagrams for encoding and decoding signals using FEC and distribution matching along with a non-linear mitigation interleaver and de-interleaver, according to some embodiments of the disclosure.

FIG. 4 illustrates an example interleaved codeword after pre-FEC interleaving and FEC encoding, according to some embodiments of the disclosure.

FIG. 5 illustrates an example of the interleaved codeword of FIG. 4 after further interleaving, according to some embodiments of the disclosure.

FIG. 6 illustrates an example of the codeword after a further interleaving step, according to some embodiments of the disclosure.

FIG. 7 illustrates content of the NLM interleaver buffer, according to some embodiments of the disclosure.

FIG. 8 illustrates a first example amplitude lane mapping for the NLM interleaver, according to some embodiments of the disclosure.

FIG. 9 illustrates an example sign lane mapping for the NLM interleaver, according to some embodiments of the disclosure.

FIG. 10 illustrates a second amplitude lane mapping for the NLM interleaver, according to some embodiments of the disclosure.

FIG. 11 illustrates a pair of block diagrams for encoding and decoding signals using FEC and distribution matching along with a non-linear mitigation interleaver and de-interleaver, and payload error decorrelator and parity interleaver, according to some embodiments of the disclosure.

FIG. 12 illustrates an example FEC encoder output for the encoder of FIG. 11, according to some embodiments of the disclosure.

FIG. 13 illustrates an example output codeword for the encoder of FIG. 11, according to some embodiments of the disclosure.

FIG. 14 illustrates a pair of block diagrams for encoding and decoding signals using FEC and distribution matching along with a non-linear mitigation interleaver and de-interleaver, with parallel encoding and decoding paths, according to some embodiments of the disclosure.

FIG. 15 illustrates an example bit mapping diagram for a 16QAM implementation with 24 codewords and 32-bit DM words, according to some embodiments of the disclosure.

### DETAILED DESCRIPTION

### Overview

As artificial intelligence (AI) applications continue to evolve, they demand unprecedented data processing speeds and bandwidth capabilities to support their complex algorithms and massive datasets. Digital signal processors (DSPs), such as optical DSPs and coherent DSPs, can enable high-bandwidth optical interconnects for AI infrastructure. In particular, the DSPs can enable low-latency, high-performance, and energy-efficient data transfer. These DSPs can offer seamless connectivity across AI, cloud computing, enterprise systems, and 5G infrastructure.

Forward error correction (FEC) is an encoding technique that adds redundant data, referred to as parity bits, to a signal at the transmitter. The receiver can use the redundant data to detect and correct errors introduced during transmission. FEC improves reliability over noisy channels, which can enable longer transmission distances and/or higher speeds with a low bit rate error. FEC is often used in combination with complex modulation schemes such as quadrature amplitude modulation (QAM), which encodes data on multiple aspects of a signal, specifically amplitude and phase. Using FEC can ensure that data can be recovered properly for complex, high data rate signals.

In standard QAM implementations, a data point has an equal probability of occupying any of the available amplitudes. To reduce the overall energy of a signal, probabilistic constellation shaping (PCS) can reduce the probability of higher-amplitude signals, thus making lower-amplitude (and lower-energy) signals more likely to be transmitted than higher-amplitude (and higher-energy) signals. Using PCS increases spectral efficiency and transmission capacity, so that an optical channel can approach or reach the Shannon channel capacity.

The PCS stage can be performed before or after FEC encoding. In an implementation of a reverse concatenation schema (RCS), a splitter splits an input data stream into two data sequences, one intended for the sign data and the other intended for the amplitude data. A distribution matching (DM) encoder performs PCS on the amplitude data, to reduce probabilities of the higher amplitude(s). An FEC encoder calculates parity bits based on the sign data and the PCS-adjusted amplitude data, and inserts the parity bits into the sign data. A mapper forms the QAM signals based on the amplitude and sign data streams.

Many FEC implementations further include interleavers to assist in handling error bursts and error correlations. An interleaver implements a deterministic and reversible permutation of an input bit sequence, so that an FEC decoder at a receiver can reverse the interleaving operation from the encoder at the transmitting side. Interleavers may mix bits from different codewords and/or spread bits of a given codeword over time. Consequently, the DM words generated by the DM encoder can be interleaved and scattered in time. In some implementations, the transmitting side includes a first interleaver after the DM encoding and before FEC encoding, and a second interleaver follows the FEC encoder. Two corresponding de-interleavers are included on the receiving side, to reverse the interleaving process on the transmitting side. The overall interleaving scheme ensures that the DM words generated by the DM encoder are correctly mapped to the appropriate mapper input lanes (e.g., to the amplitude lane).

The DM process described above reduces the energy of DM codewords. When interleaving steps are included, bits from multiple DM codewords are mixed and distributed across the transmitted sequence, which leads to a temporary energy distribution with greater amplitude variance than that of individual DM codewords. Although the average signal energy remains unchanged, this increased variance can exacerbate the effects of optical channel non-linearities and degrade overall system performance.

As described herein, a FEC encoder with a PCS stage may further include a non-linear mitigation (NLM) interleaver to address the increased amplitude variance introduced by conventional interleaving schemes in reverse concatenation architectures. On the transmitter side, an NLM interleaver may be included as an additional interleaver, following DM encoding and FEC encoding, and earlier interleaving steps. The encoder may include the first interleaver and second interleaver described above, along with a third NLM interleaver. The NLM interleaver buffers an amplitude signal output by the second interleaver (or more generally, a post-FEC interleaving operation). The NLM interleaver permutes the buffered data to reassemble groups of amplitude bits, e.g., DM codewords. This targeted permutation reduces the temporary energy variance that would otherwise result from scattering bits of multiple DM codewords, thereby mitigating the adverse effects of optical channel non-linearities. The NLM interleaver can be configured to operate in various modes, including single polarization, dual polarization, and lane-shifting sequences, to uniformly distribute amplitude bits across mapper input lanes.

In some embodiments, the FEC encoder may be a staircase encoder or a semi-infinite codeword encoder, and the system may include additional components such as payload and parity error decorrelators to support the FEC encoder. The architecture supports flexible interleaving strategies, including interleaving across multiple codewords and polarization modes, to optimize energy distribution and system robustness.

On the receiver side, corresponding de-interleaving and decoding devices are provided. These include a demapper, an NLM de-interleaver configured to reverse the NLM interleaving operation, a FEC decoder, and a DM decoder. The NLM de-interleaver ensures that amplitude bits are correctly reassembled prior to FEC and DM decoding, thereby preserving the benefits of reduced non-linear distortion throughout the transmission chain. The receiver includes additional de-interleavers to reverse the interleaving operations at the transmitter.

Overall, encoding and decoding architectures described herein enable high spectral efficiency and improved transmission performance in optical communication systems by combining PCS, advanced FEC, and an interleaving architecture that addresses the challenges posed by non-linear channel effects.

### Example RCS Architecture

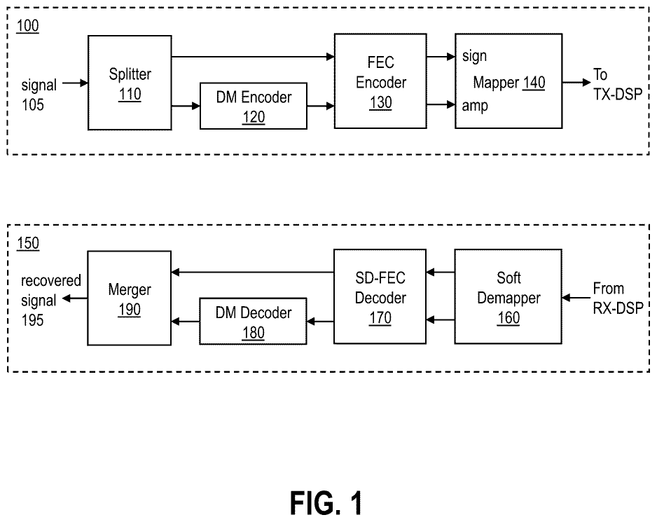

FIG. 1 illustrates a pair of block diagrams for encoding and decoding signals using FEC and distribution matching with an RCS arrangement. Transmitter section 100 receives input data signal 105, which is provided to splitter 110. Splitter 110 divides the input data stream into two sequences: a first sequence is directed to DM encoder 120, and a second sequence is provided directly to FEC encoder 130. The first sequence is made up of bits that determine the sign (i.e., the positive or negative polarity) of the in-phase (I) and quadrature (Q) components of the QAM symbols. These are often referred to as “sign bits” or “sign data.” The second sequence is made up of bits that determine the amplitude levels of the I and Q components. This sequence is referred to as the “amplitude data” or “amplitude bits.”

DM encoder 120 applies probabilistic constellation shaping to the amplitude data, generating DM-encoded bits with a controlled probability distribution to reduce the likelihood of higher-amplitude symbols and thereby lower the average signal energy.

The output of DM encoder 120 and the first sequence from splitter 110 are provided to FEC encoder 130. FEC encoder 130 generates parity bits based on both of the input sequences (the first sequence from splitter 110 and the DM-encoded second sequence from DM encoder 120). FEC encoder 130 inserts the parity bits into the data stream, and in particular, into the sign data. The parity bits add redundancy to the data stream, enabling error detection and correction at the receiver.

The output of FEC encoder 130 is supplied to mapper 140, which assigns the encoded bits to the designated sign and amplitude components for QAM transmission. The mapped signal is then forwarded to the transmit-side digital signal processor (TX-DSP) for further processing and transmission over the optical channel.

Receiver section 150 processes a signal received from the optical channel, e.g., from a receive-side DSP (RX-DSP), to generate recovered signal 195. The received signal is first provided to soft demapper 160, which extracts soft information for the sign and amplitude bits from the received QAM symbols. The soft information is then decoded by soft-decision FEC (SD-FEC) decoder 170, which utilizes the redundancy added at the transmitter to correct errors introduced during transmission.

The output of SD-FEC decoder 170 is provided to DM decoder 180, which reverses the probabilistic shaping applied at the transmitter and reconstructs the original amplitude data. Finally, a merger 190 combines the outputs of DM decoder 180 and SD-FEC decoder 170 to recover the original data stream, yielding recovered signal 195.

### Example RCS Architecture With Interleaving

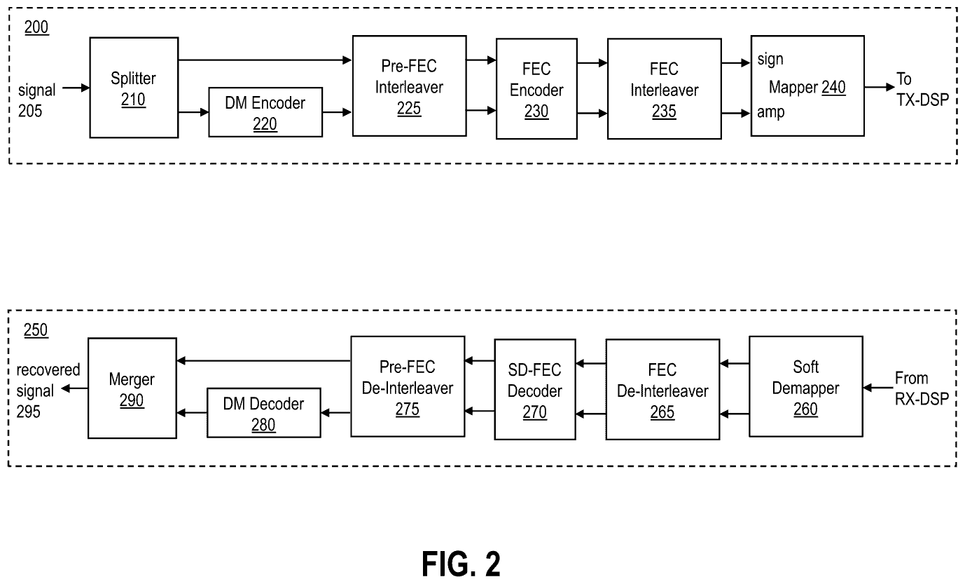

FIG. 2 illustrates a pair of block diagrams for encoding and decoding signals using FEC and distribution matching with additional interleaving and de-interleaving steps. Transmitter section 200 receives input data signal 205, which is provided to splitter 210. Splitter 210 divides the input data stream into two sequences, which are similar to the two sequences output by splitter 110, described above. As in FIG. 1, the second sequence is provided to DM encoder 220, which is similar to DM encoder 120.

The first sequence from splitter 210, along with an output of DM encoder 220 (the DM-encoded second sequence), is provided to pre-FEC interleaver 225. Pre-FEC interleaver 225 performs a deterministic and reversible permutation of one or both of the received sequences, distributing bits within a given sequence across time or codewords to mitigate error bursts and correlations. For example, pre-FEC interleaver 225 permutes the DM-encoded bits from DM encoder 220, and in some cases, may also permute the first sequence of bits (the sign bits). The interleaved data is provided to FEC encoder 230, which adds redundancy for error correction, as described with respect to FEC encoder 130.

The output of FEC encoder 230 is further processed by FEC interleaver 235. FEC interleaver 235 permutes the encoded bits (including the parity bits inserted in the first data sequence) to further disperse potential error patterns and enhance the effectiveness of the FEC decoder at the receiver. FEC interleaver 235 outputs two sequences, one corresponding to sign and the other to amplitude, to mapper 240. Mapper 240 outputs the QAM signal as described with respect to mapper 140.

Receiver section 250 includes soft demapper 260, SD-FEC decoder 270, DM decoder 280, and merger 290, which may be similar to soft demapper 160, SD-FEC decoder 170, DM decoder 180, and merger 190 described with respect to FIG. 1. Receiver section 250 further includes FEC de-interleaver 265 and pre-FEC de-interleaver 275. FEC de-interleaver 265 is between soft demapper 260 and SD-FEC decoder 270 to reverse the interleaving performed by FEC interleaver 235, restoring the original order of the FEC-encoded bits. Pre-FEC de-interleaver 275 is between SD-FEC decoder 270 and DM decoder 280 and reverses the interleaving performed by pre-FEC interleaver 225, reconstructing the original order of the DM-encoded bits before DM decoding.

In some cases, the FEC interleaving function is implemented as a two-stage process. After FEC encoding at FEC encoder 230, the encoded data is first processed by a DM post-FEC interleaver, which buffers and permutes the amplitude and sign bits to further disperse the distribution-matched codewords. The output of the DM post-FEC interleaver is then provided to a subsequent FEC interleaver, which performs an additional permutation across multiple codewords and parity bits. This two-stage interleaving approach enhances the dispersion of error patterns and ensures that the amplitude bits are correctly aligned for subsequent mapping and transmission. Corresponding de-interleaving stages are implemented in the receiver path to reverse these permutations and restore the original data order prior to decoding.

### Example RCS Architecture With NLM Interleaving

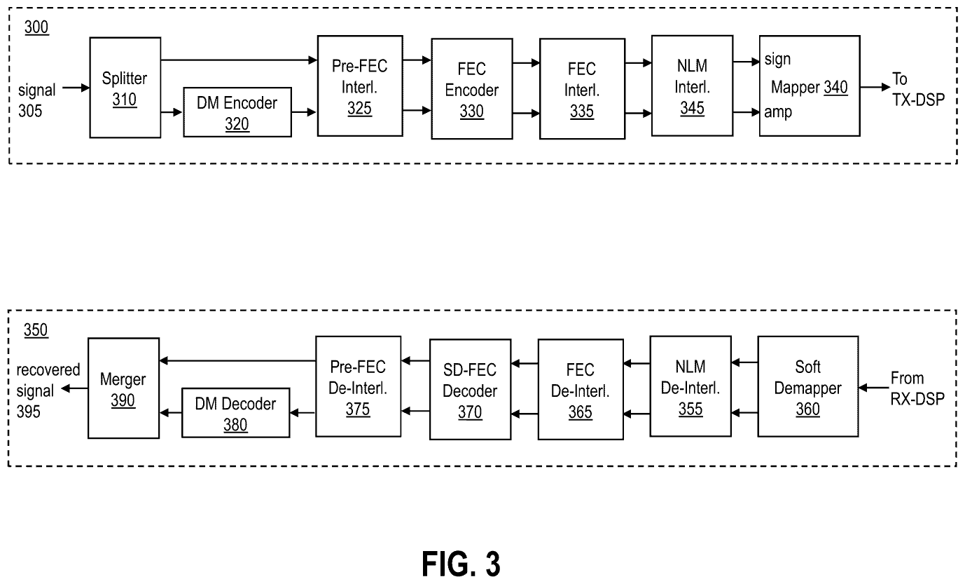

FIG. 3 illustrates a pair of block diagrams for encoding and decoding signals using FEC and distribution matching along with a NLM interleaver and NLM de-interleaver, according to some embodiments of the disclosure. More specifically, FIG. 3 is an embodiment of a RCS for encoding and decoding a QAM signal, incorporating a NLM interleaver and corresponding NLM de-interleaver, in addition to the interleaving and de-interleaving stages of FIG. 2.

In transmitter section 300, input signal 305 is provided to splitter 310, which divides the data stream into a first sequence (e.g., a sign sequence) and a second sequence (e.g., an amplitude sequence). The amplitude sequence is processed by DM encoder 320, which generates distribution-matched codewords for probabilistic constellation shaping.

The output of DM encoder 320 is provided to pre-FEC interleaver 325. Pre-FEC interleaver 325 applies a deterministic and reversible permutation to the DM-encoded bits, distributing them across time or codewords. The interleaved data is then encoded by an FEC encoder 330, which generates parity bits based on the interleaved sign and amplitude data. The output of the FEC encoder 330 is further processed by FEC interleaver 335, which permutes the encoded bits, including parity bits, to further disperse potential error patterns. Splitter 310, DM encoder 320, pre-FEC interleaver 325, FEC encoder 330, and FEC interleaver 335 are similar to splitter 210, DM encoder 220, pre-FEC interleaver 225, FEC encoder 230, and FEC interleaver 235 of FIG. 2, described above.

The output of the FEC interleaver 335 is provided to and processed by NLM interleaver 345. NLM interleaver 345 buffers the amplitude signal output by the FEC interleaver and permutes the buffered amplitude bits to reduce energy variance in the encoded QAM signal. In some embodiments, the NLM interleaver 345 may reassemble distribution-matched codewords or assign consecutive bits to amplitude lanes according to a lane-shifting sequence.

The permuted sign and amplitude bits from NLM interleaver 345 are provided to mapper 340, which assigns the bits to the appropriate I/Q components for QAM symbol generation and transmission, as described with respect to mapper 240.

In the receiver section 350, a received signal is first processed by a soft demapper 360, which extracts soft information for the sign and amplitude bits from the received QAM symbols, as described with respect to soft demapper 160 and soft demapper 260. The output of the soft demapper 360 is provided to and processed by NLM de-interleaver 355. NLM de-interleaver 355 buffers the amplitude bits and reverses the permutation applied by the NLM interleaver 345 at the transmitter, thereby restoring the order of the amplitude bits.

The output of NLM interleaver 345 is processed by FEC de-interleaver 365, which reverses the permutation applied by the FEC interleaver 335. SD-FEC decoder 370 performs error correction using the restored bit sequence. Pre-FEC de-interleaver 375 reverses the permutation applied by the pre-FEC interleaver 325, reconstructing the original order of the DM-encoded bits. DM decoder 380 recovers the original amplitude data, and the merger 390 combines the recovered amplitude and sign data to generate recovered signal 395. FEC de-interleaver 365, SD-FEC decoder 370, pre-FEC de-interleaver 375, DM decoder 380, and merger 390 may be similar to the FEC de-interleaver 265, SD-FEC decoder 270, pre-FEC de-interleaver 275, DM decoder 280, and merger 290 of FIG. 2, described above.

The architecture shown in FIG. 3 includes three interleaving operations in the transmitter path, referred to as pre-FEC interleaving, FEC interleaving, and non-linearities mitigation interleaving, and corresponding de-interleaving operations in the receiver path. Including the NLM interleaver and the NLM de-interleaver enables reduction of energy variance in the amplitude signal, thereby mitigating non-linear effects in the encoded QAM signal. As noted with respect to FIG. 2, in some implementations, the FEC interleaver 335 and FEC de-interleaver 365 may each be implemented as two separate interleaving/de-interleaving stages; in such implementations, there are four interleaving operations and four corresponding de-interleaving operations.

### Example Interleaving Schemes

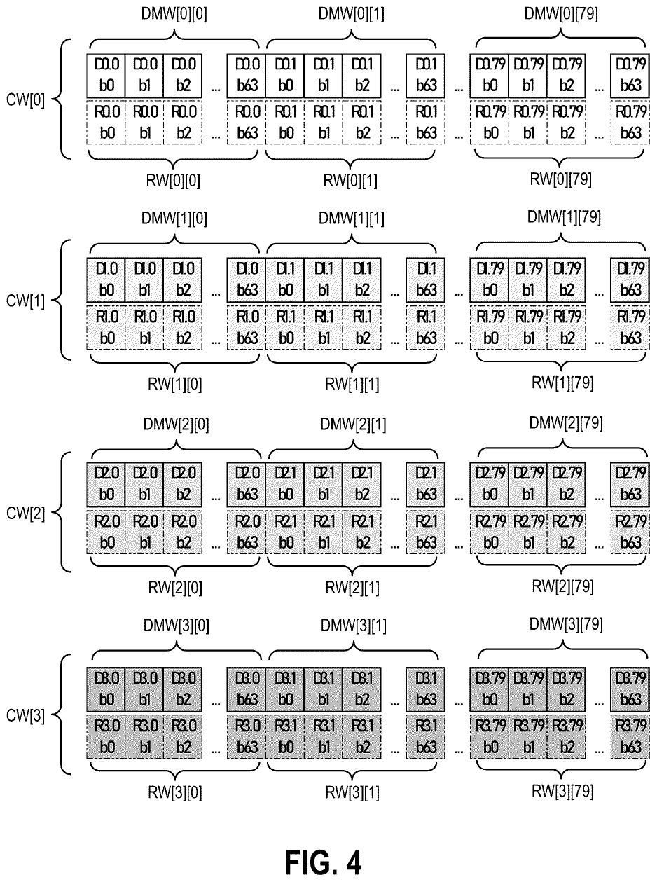

FIG. 4 illustrates an example interleaved codeword after pre-FEC interleaving and FEC encoding according to some embodiments of the disclosure. FIG. 4 is an example result of a QAM16 signal following pre-FEC interleaving at pre-FEC interleaver 325 and FEC encoding at FEC encoder 330. In this example, the FEC code has a systematic fixed word length code with a codeword length of (N=10×1024) bits and a dimension of (K=8×1024), resulting in a 25% FEC overhead. This systematic code passes input bits unmodified and unpermuted to the output codeword, with parity bits added at the end. The codewords may be labeled as CW[i]=(CW[i].b[0], CW[i].b[1], CW[i].b[2], . . . , CW[i].b[10239]), where (i) refers to the (i)-th transmitted codeword, CW[i].b[0] refers to the first bit of the codeword, CW[i].b[1] refers to the second transmitted bit, and so on. Different shading represents different codewords. Solid outlining represents DM words (corresponding to amplitude data), and dashed outlining represents random words (corresponding to sign data, where “random” refers to a random distribution, as opposed to the PCS distribution of the amplitude data). Each CW includes a set of DM words and random words, e.g., CW[0] includes DMW[0][0], DMW[0][1], etc., and RW[0][0], RW[0][1], etc. Each DMW and RW includes a set of labeled bits, e.g., DMW[0][0] includes bits D0.0 b0, D0.0 b1, . . . D0.0 b63.

More specifically, DM encoder 320 operates with 64-bit output words. Each DM word is denoted as (D[i][j]=(D[i][j].b[0], D[i] [j].b[1], D[i][j].b[2], . . . , D[i][j].b[63])), where (i) indicates the FEC codeword to which the DM block belongs, and (j) represents the (j)-th DM word within the FEC codeword. The bits within each DM word are sequentially labeled, with (D[i].[j].b[0]) being the first bit, (D[i].[j].b[1]) the second bit, and so forth. Note that in the individual bits, the brackets are removed in the figures.

For the FEC codeword bits mapped to sign bits, the sign bit section is divided into 64-bit words of consecutive bits, labeled as (R[i] [j]). This can be expressed as (R[i][j]=(R[i][j].b[0], R[i][j].b[1], R[i][j].b[2], . . . , R[i][j].b[63])), which corresponds to (CW[i].b[5120+j·64+0], CW[i].b[5120+j·64+1], CW[i].b[5120+j·64+2], . . . , CW[i].b[5120+j·64+63]).

The pre-FEC interleaver 325 organizes the data such that the first half of the FEC codeword contains all the amplitude bits, arranged in consecutive 64-bit DM words. Consequently, at the output of the FEC encoder, a codeword can be represented as follows:

[CW[i]=(CW[i].b[0], CW[i].b[1], CW[i].b[2], . . . , CW[i].b[10239])=D[i][0]∩D[i][1]∩D[i][2]∩ . . . ∩D[i][79]∩R[i][0]∩R[i][1]∩R[i][2]∩ . . . ∩R[i][79]]
where (∩) denotes the concatenation of sequences.

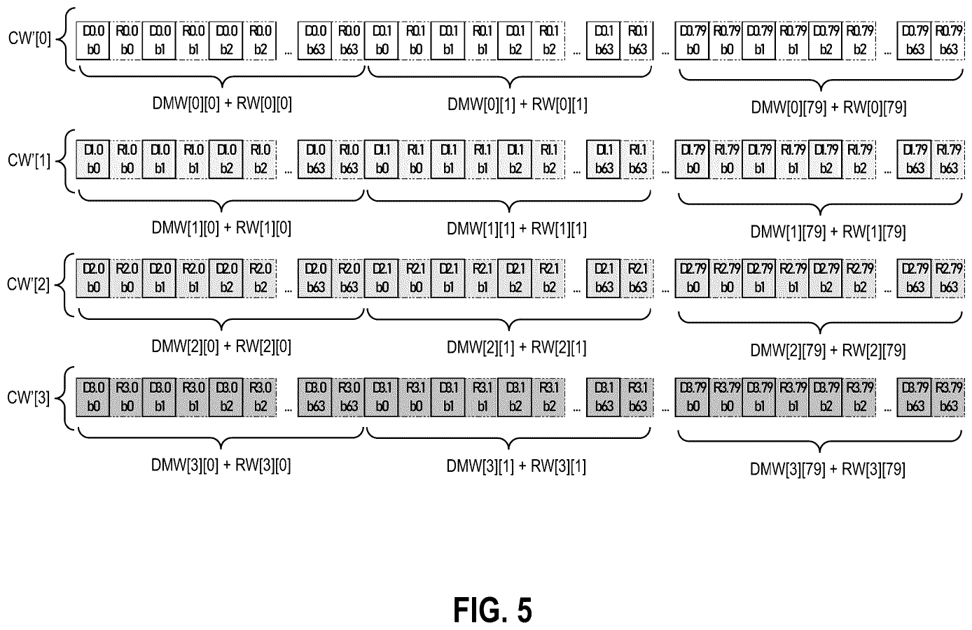

FIG. 5 illustrates an example of the interleaved and FEC-encoded codeword of FIG. 4 after further interleaving at FEC interleaver 335, according to some embodiments of the disclosure. The FEC interleaver 335 buffers an entire FEC codeword (10,240 bits in length), splits the codeword into two halves (the first half containing amplitude bits and the second half containing sign bits), and then delivers pairs of bits using a round-robin interleaving method between amplitude and sign bits. If the FEC interleaver 335 input word is expressed as CW[i]=D[i][0]∩D[i]∩D[i][2]∩ . . . ∩D[i][79]∩R[i][0]∩R[i][1]∩R[i][2] . . . R[i].[79], then its output word can be expressed as: CW'[i]=(D[i][0].b[0], R[i][0].b[0], D[i].b[1], R[i][0].b[1], . . . D[i][0].b[63], R[i][0].b[63], D[i][1].b[0], R[i][1].b[0], D [i][1].b[1], R [i][1].b[1], . . . D[i][1].b[63], R[i][1].b[63], . . . , D[i][79].b[63], R[i].b[63]).

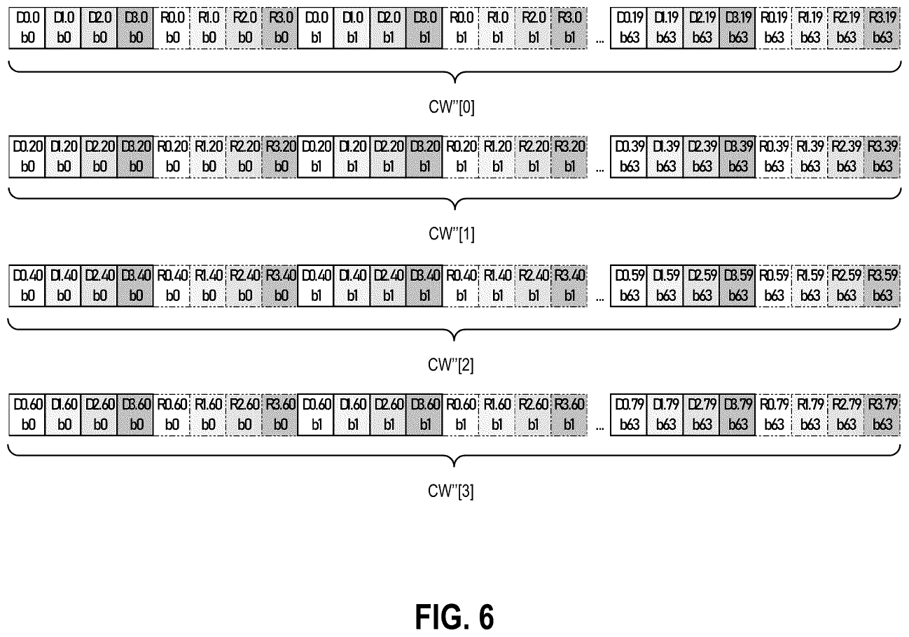

FIG. 6 illustrates an example of the codeword after a further interleaving step, according to some embodiments of the disclosure. As noted with respect to FIGS. 2 and 3, in some implementations, the FEC interleaver 235 or 335 represents two sequential interleaving processes (which may be implemented as two separate interleavers), and an output of the second interleaver is shown in FIG. 6. This interleaver operates by mixing bits of 4 different codewords in a round-robin fashion. If the input sequence of the FEC interleaver (FEC_int.inseq) is FEC_int.inseq=(CW[0], CW[1], CW[2], CW[3], CW[4], CW[5], CW[6], CW[7], . . . ) then the output sequence (FEC_int.outseq) is FEC_int.outseq=(CW[0].b[0], CW[1].b[0], CW[2].b[0], CW[3].b[0], CW[0].b[1], CW[1].b[1], CW[2].b[1], CW[3].b[1], CW[0].b[2], . . . CW[3].b[10239], CW[4].b[0], CW[5].b[0], . . . ). The output bit sequence of the FEC interleaver 335 is split in blocks of 10×1024 bits to match the length of the input FEC codewords. The 10×1024 consecutive bit blocks are referred to as FEC interleaver output codewords, and are labeled as CW″[i], with i referring to the ith output codeword. That is, FEC_int.outseq=(CW″[1], CW″[2], CW″[3], CW″[4]. . . ); with CW″[0] being the sequence of the first 10*1024 consecutive bits output by FEC interleaver 335, CW″[1] being the sequence of the second 10*1024 consecutive bits output by FEC interleaver 335, CW″[2] being the sequence of the third 10*1024 bits output by FEC interleaver 335, and so on.

As shown in FIG. 3, NLM interleaver 345 is positioned at the output of the FEC interleaver 335 (e.g., the output of the second interleaver represented by FEC interleaver 335). In this example, NLM interleaver 345 buffers blocks of 2,048 bits, organized as (64×2×4×4) bits. Due to the combined operations of the pre-FEC interleaver 325, FEC interleaver, and DM-post-FEC interleaver, each 2,048-bit block contains 16 blocks of 64-bit DM words and 16 blocks of 64-bit random data words. Each of the four codewords contributes a quarter of the DM words and a quarter of the random words.

The content of the buffer is labeled as NLMI.inW (NLM interleaver input word), and it can be expressed as NLMI.inW[k]=(CW″[i].b[2048*k: 2048*k+2047])=(CW″[i].b[2048*k+0], CW″[i].b[2048*k+1], CW″[i].b[2048*k+2], . . . , CW″[i].b[2048*k+2047])=(D[i].[k*16+0].b[0], R[i].[k*16+0].b[0], D[i].[k*16+0].b[1], R[i]. [k*16+0].b[1], . . . , D[i].[k*16+15].b[63], R[i].[k*16+15].b[63]), with k being an index to numerate blocks of 2048 consecutive bits inside the 10240-bit FEC codeword (0≤k≤5).

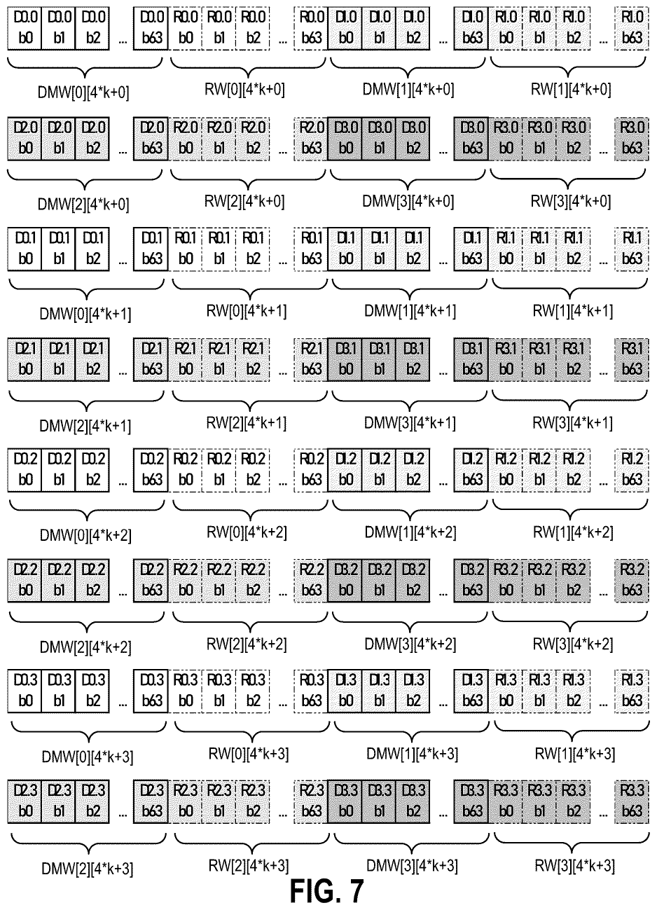

FIG. 7 illustrates the content of a buffer of an NLM interleaver buffer, e.g., a buffer of NLM interleaver 345, according to some embodiments of the disclosure. In this example, the bits of each DM word and the bits of the random words are grouped and drawn together, since this permutation does not change the buffer operation.

NLM interleaver 345 generates 8 sets of bits that correspond to 4 amplitude lanes (AL[0], AL[1], . . . AL[3]) and 4 sign lanes (SL[0], SL[1], . . . SL[3]) of the QAM16 dual polarization mapper. Then NLM interleaver 345 mixes the data according to a predetermined permutation. For example, NLM interleaver 345 may mix the data according to a procedure for a single lane mode, a single polarization mode, or a dual polarization mode.

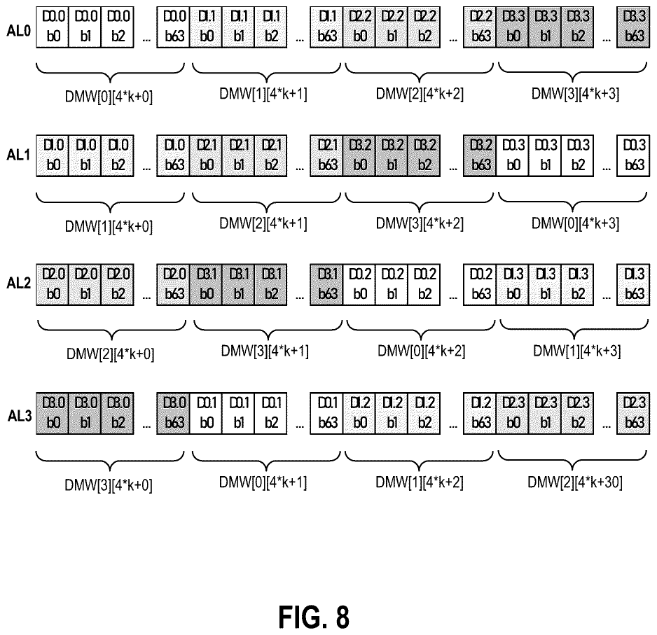

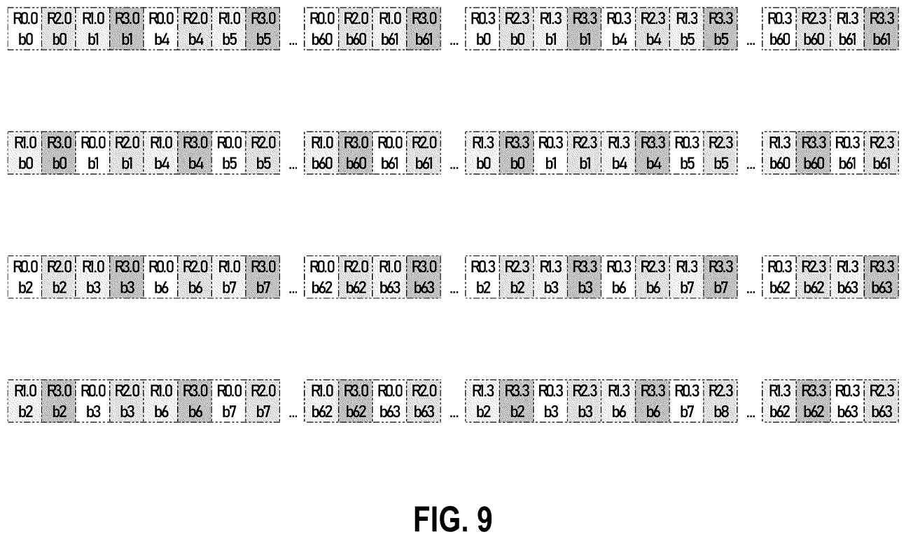

FIGS. 8 and 9 illustrate example lane mappings for the single lane mode. In the single lane mode, for amplitude lanes, NLM interleaver 345 sends the bits in a consecutive way of the m^{th} DM word belonging to each n^{th} FEC codeword to the ((n+m*(4−1))%4)^{th} amplitude lane. That is, NLM interleaver 345 sends the 1^{st} DM word of the 1^{st} FEC codeword to the 1^{st} amplitude lane, the 1^{st} DM word of the 2^{nd} FEC codeword to the 2^{nd} amplitude lane, the 1^{st} DM word of the 3^{rd} FEC codeword to the 3^{rd} amplitude lane, and the 1^{st} DM word of the 4^{th} FEC codeword to the 4^{th} amplitude lane. Next, NLM interleaver 345 sends the 2^{nd} DM word of the 1^{st} FEC codeword to the 2^{nd} amplitude lane, the 2^{nd} DM word of the 2^{nd} FEC codeword to the 3^{rd} amplitude lane, and so on, until all the DM words of the buffered block are sent. A similar operation can be achieved using ((n+m)%4) as an equation, which translates to an inverse lane-shifting operation.

FIG. 8 illustrates a first example amplitude lane mapping in the single lane mode. The amplitude mapping can also be expressed as follows:
AL[0]=D[i+0][k*4+0]∩D[i+1][k*4+1]∩D[i+2][k*4+2]∩D[i+3][k*4+3]
AL[1]=D[i+1][k*4+0]∩D[i+2][k*4+1]∩D[i+3] [k*4+2]∩D[i+0][k*4+3]
AL[2]=D[i+2][k*4+0]∩D[i+3][k*4+1]∩D[i+0] [k*4+2]∩D[i+1][k*4+3]
AL[3]=D[i+3][k*4+0]∩D[i+0][k*4+1]∩D[i+1] [k*4+2]∩D[i+2][k*4+3]

With:
AL[0]=HI amplitude lane
AL[1]=HQ amplitude lane
AL[2]=VI amplitude lane
AL[3]=VQ amplitude lane

FIG. 9 illustrates an example sign lane mapping of NLM interleaver 345 in the single lane mode, according to some embodiments of the disclosure.

In general, the sign lanes may be interleaved optimally according to the default FEC interleaver, e.g., FEC interleaver 335. For example, take a block of (n) bits (one per each codeword in the interleaver; in this case, 4) and distribute those bits to the sign lanes of one polarization. For the next block of (n) bits, perform a similar distribution but shift the sign lane index by 1. Repeat this process with a different incremental index shift for each sign lane in each polarization. Then, take the next group of (k×n) bits (with (k) being the number of sign lanes per polarization; typically, (k=2)) and repeat the process for the sign lanes of the other polarization. Continue this process until all the sign bits in the NLMI buffer block are used.

The sign lane mapping can also be expressed as follows:
SL[0]=(R[i+0][k*4+0].b[0], R[i+2][k*4+0].b[0], R[i+1] [k*4+0].b[1], R[i+3][k*4+0].b[1], . . .
SL[1]=(R[i+1][k*4+0].b[0], R[i+3][k*4+0].b[0], R[i+0] [k*4+0].b[1], R[i+2][k*4+0].b[1], . . .
SL[2]=(R[i+0][k*4+0].b[2], R[i+2][k*4+0].b[2], R[i+1] [k*4+0].b[3], R[i+3][k*4+0].b[3], . . .
SL[3]=(R[i+1][k*4+0].b[2], R[i+3][k*4+0].b[2], R[i+0] [k*4+0].b[3], R[i+2][k*4+0].b[3], . . .

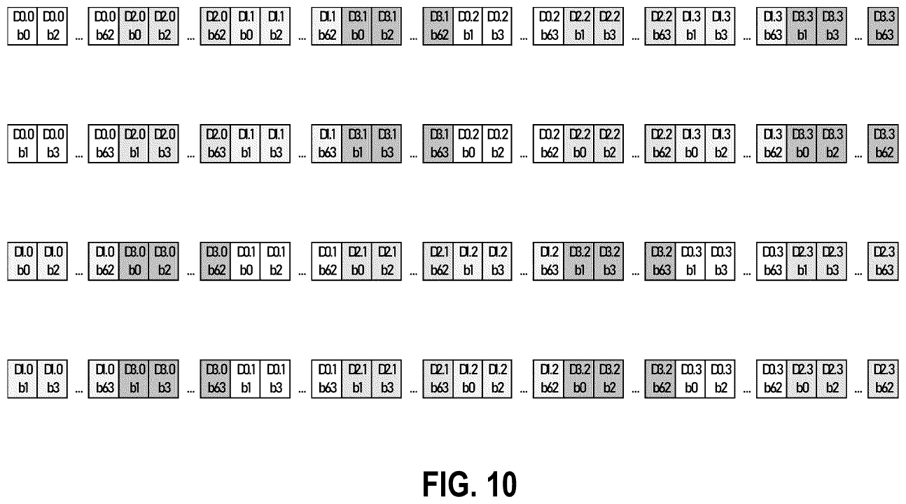

As an alternative to the single lane mode, the NLM interleaver 345 may operate in a single polarization mode that assigns even and odd bits of each distribution-matched word to in-phase and quadrature amplitude lanes of the same polarization. In the single polarization mode, for the amplitude lanes, NLM interleaver 345 splits each DM word into even and odd bits, and sends the consecutive even or odd bits of that DM word to a specific amplitude lane. FIG. 10 illustrates a second amplitude lane mapping for the NLM interleaver, according to the single polarization mode.

An example process for assigning even and odd bits of DM words to each amplitude lane is as follows. NLM interleaver 345 forms groups of (n) DM words, each belonging to a different FEC codeword, with (n) being the number of different codewords per interleaver block. These groups can be referred to as sub-packets. Then, NLM interleaver 345 forms a group of 4 sub-packets, which are referred to as a packet.

For the 1st sub-packet of each packet, NLM interleaver 345 sends DM words from even-numbered codewords to the amplitude lanes of polarization H (one polarization) and DM words from odd-numbered codewords to the amplitude lanes of polarization V (the other polarization). Additionally, for these 1st sub-packets, NLM interleaver 345 sends the even bits of each DM word to the I component of the corresponding polarization and the odd bits to the Q component.

For the 2nd sub-packet of each packet, NLM interleaver 345 sends DM words from odd-numbered codewords to the amplitude lanes of polarization H and DM words from even-numbered codewords to the amplitude lanes of polarization V. Similarly, for these 2nd sub-packets, NLM interleaver 345 sends the even bits of each DM word to the I component of the corresponding polarization and the odd bits to the Q component.

For the 3rd sub-packet of each packet, NLM interleaver 345 sends DM words from even-numbered codewords to the amplitude lanes of polarization H and DM words from odd-numbered codewords to the amplitude lanes of polarization V. For these 3rd sub-packets, NLM interleaver 345 sends the odd bits of each DM word to the I component of the corresponding polarization and the even bits to the Q component.

For the 4th sub-packet of each packet, NLM interleaver 345 sends DM words from odd-numbered codewords to the amplitude lanes of polarization H and DM words from even-numbered codewords to the amplitude lanes of polarization V. For these 4th sub-packets, NLM interleaver 345 sends the odd bits of each DM word to the I component of the corresponding polarization and the even bits to the Q component.

The amplitude mapping for the single polarization mode can be expressed as follows:
AL[0]=D[i+0][k*4+0]. even∩D[i+2] [k*4+0]. even∩D[i+1][k*4+1]. even∩D[i+3][k*4+1]. even∩
D[i+0][k*4+2]. odd ∩D[i+2][k*4+2]. odd ∩D[i+1] [k*4+3]. odd ∩D[i+3][k*4+3]. odd . . .
AL[1]=D[i+0][k*4+0]. odd ∩D[i+2][k*4+0]. odd ∩D[i+1][k*4+1]. odd ∩D[i+3][k*4+1]. odd∩
D[i+0][k*4+2]. even∩D[i+2][k*4+2]. even∩D[i+1] [k*4+3]. even∩D[i+3][k*4+3]. even . . .
AL[2]=D[i+1][k*4+0]. even∩D[i+3] [k*4+0]. even∩D[i+0][k*4+1]. even∩D[i+2][k*4+1]. even∩
D[i+1][k*4+2]. odd ∩D[i+3][k*4+2]. odd ∩D[i+0] [k*4+3]. odd ∩D[i+2][k*4+3]. odd . . .
AL[3]=D[i+1][k*4+0]. odd ∩D[i+3][k*4+0]. odd ∩D[i+0][k*4+1]. odd ∩D[i+2][k*4+1]. odd∩
D[i+1][k*4+2]. even∩D[i+3][k*4+2]. even∩D[i+0] [k*4+3]. even∩D[i+2][k*4+3]. even . . .

With:
DMW[i][j]. even=(D[i][j].b[0], D[i][j].b[2], D[i] [j].b[4], . . . , D[i][j].b[62])
DMW[i][j]. odd=(d[i][j].b[1], D[i][j].b[3], D[i][j].b[5], . . . , D[i][j].b[63])

As in the single lane mode, in the single polarization mode, sign lanes are interleaved according to the FEC interleaver, e.g., NLM interleaver 345. For example, the sign mapping illustrated in FIG. 9 and described above may also be used in the single polarization mode.

As yet another example, the NLM interleaver 345 may operate in a dual polarization mode that distributes groups of bits from a plurality of distribution-matched words across amplitude lanes of different polarizations according to a lane-shifting sequence. In the dual polarization mode, for the amplitude lanes, NLM interleaver 345 splits each DM word into four groups of bits: bits with cardinal indices that are multiples of 4 (referred to as (g[0])), multiples of 4 plus 1 (referred to as (g[1])), multiples of 4 plus 2 (referred to as (g[2])), and multiples of 4 plus 3 (referred to as (g[3])). NLM interleaver 345 sends the consecutive bits of these groups to a specific amplitude lane. The process for assigning (g[0]), (g[1]), (g[2]), and (g[3]) bits of each DM word to amplitude lanes is as follows.

NLM interleaver 345 forms groups of (n) DM words, each belonging to a different FEC codeword, with (n) being the number of different codewords per interleaver block. These groups can be referred to as DM-sub-packets. Then, NLM interleaver 345 forms a group of 4 DM-sub-packets, which are referred to as a packet.

For the (m)-th sub-packet, send the (g[x]) group (with (x) in {0, 1, 2, 3}) to the (AL[(x+m) % 4]) amplitude lane. In other words:

For the 1st sub-packet of each packet, NLM interleaver 345 sends (g[0]) bits of DM words to (AL[0]) lane (H polarization I amplitude lane), (g[1]) bits to (AL[1]) lane (H polarization Q amplitude lane), (g[2]) bits to (AL[2]) lane (V polarization I amplitude lane), and (g[3]) bits to (AL[3]) lane (V polarization Q amplitude lane).

For the 2nd sub-packet of each packet, NLM interleaver 345 sends (g[0]) bits of DM words to (AL[1]) lane, (g[1]) bits to (AL[2]) lane, (g[2]) bits to (AL[3]) lane, and (g[3]) bits to (AL[0]) lane.

For the 3rd sub-packet of each packet, NLM interleaver 345 sends (g[0]) bits of DM words to (AL[2]) lane, (g[1]) bits to (AL[3]) lane, (g[2]) bits to (AL[0]) lane, and (g[3]) bits to (AL[1]) lane.

For the 4th sub-packet of each packet, NLM interleaver 345 sends (g[0]) bits of DM words to (AL[3]) lane, (g[1]) bits to (AL[0]) lane, (g[2]) bits to (AL[1]) lane, and (g[3]) bits to (AL[2]) lane.

The amplitude mapping for the dual polarization mode can be expressed as follows:
AL[0]=D[i+0][k*4+0]. g0∩D[i+1][k*4+0]. g0∩ . . . ∩D[i+3][k*4+0]. g0∩D[i+0][k*4+1]. g1∩ . . .
AL[1]=D[i+0][k*4+0]. g1∩D[i+1][k*4+0]. g1∩ . . . ∩D[i+3][k*4+0]. g1∩D[i+0][k*4+1]. g2∩ . . .
AL[2]=D[i+0][k*4+0]. g2∩D[i+1][k*4+0]. g2∩ . . . ∩D[i+3][k*4+0]. g2∩D[i+0][k*4+1]. g3∩ . . .
AL[3]=D[i+0][k*4+0]. g3∩D[i+1][k*4+0]. g3∩ . . . ∩D[i+3][k*4+0]. g3∩D[i+0][k*4+1]. g0∩ . . .

With:
D[i][j]. g[0]=(D[i][j].b[0], D[i][j].b[4], D[i][j].b[8], . . . , D[i][j].b[60])
D[i][j]. g[1]=(D[i][j].b[1], D[i][j].b[5], D[i][j].b[9], . . . , D[i][j].b[61])
D[i][j]. g[2]=(D[i][j].b[2], D[i][j].b[6], D[i][j].b[10], . . . , D[i][j].b[62])
D[i][j]. g[3]=(D[i][j].b[3], D[i][j].b[7], D[i][j].b[11], . . . , D[i][j].b[63])

As in the single lane mode and the single polarization mode, in the dual polarization mode, the sign lanes are interleaved according to the FEC interleaver, e.g., NLM interleaver 345. For example, the sign mapping illustrated in FIG. 9 and described above may also be used in the dual polarization mode.

### Example RCS Architecture With NLM Interleaving and Payload Error Decorrelator and Parity Interleaver

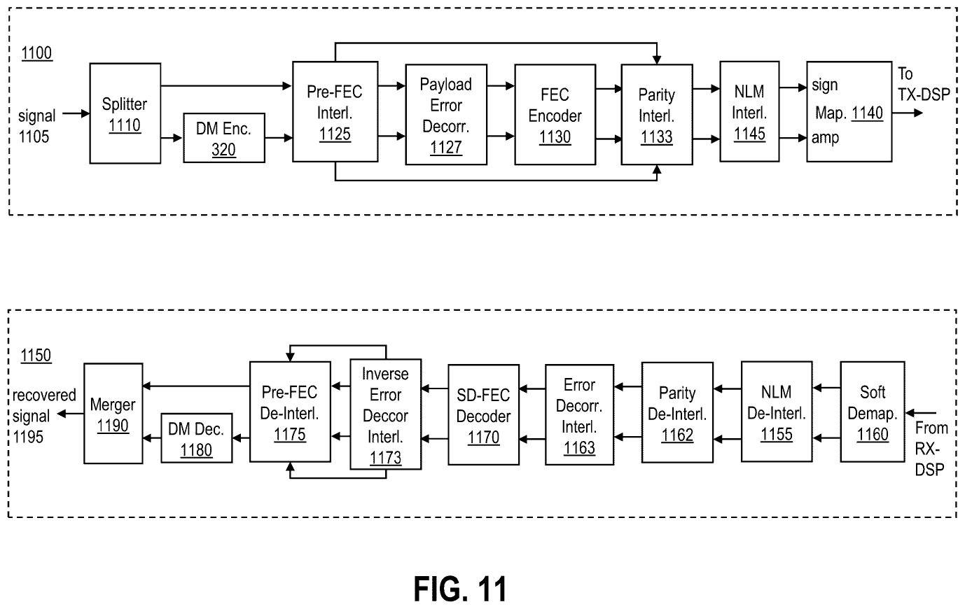

FIG. 11 illustrates a pair of block diagrams for encoding and decoding signals using FEC and distribution matching along with a non-linear mitigation interleaver and de-interleaver, and payload error decorrelator and parity interleaver, according to some embodiments of the disclosure. Like previous block diagrams, FIG. 11 includes transmitter section 1100 and corresponding receiver section 1150. In this example, FEC encoder 1130 may be a staircase encoder, which may operate in conjunction with a payload error decorrelator operating on the codeword payload and a parity interleaver for interleaving parity bits.

In transmitter section 1100, input signal 1105 is provided to splitter 1110, which divides the data stream into a first sequence, such as a sign sequence, and a second sequence, such as an amplitude sequence. The amplitude sequence is processed by DM encoder 1120, which generates distribution-matched codewords for probabilistic constellation shaping. The output of DM encoder 1120 is provided to pre-FEC interleaver 1125, which applies a deterministic and reversible permutation to the DM-encoded bits, distributing them across time or codewords to enhance error resilience. Splitter 1110, DM encoder 1120, and pre-FEC interleaver 1125 may be similar to splitter 310, DM encoder 320, and pre-FEC interleaver 325.

Following pre-FEC interleaving, the data is processed by payload error decorrelator 1127. The payload error decorrelator modifies the input to FEC encoder 1130 to decorrelate error patterns in the payload portion of the codeword. In some embodiments, payload error decorrelator 1127 is configured to modify the encoder input without interleaving the payload bits. FEC encoder 1130 generates codewords having a payload portion and a parity portion, with parity bits added based on both the sign and amplitude data. In certain embodiments, the FEC encoder may comprise a staircase encoder configured to generate codewords with distinct payload and parity portions.

The output of FEC encoder 1130 is provided to parity interleaver 1133, which permutes the parity bits to further disperse error patterns and enhance error correction performance. The parity interleaver may buffer a plurality of DM words generated from the amplitude sequence and a plurality of random words generated from the sign sequence, where the random words are further derived from the parity portion. The output of the parity interleaver 1133 is then processed by NLM interleaver 1145, which buffers the amplitude signal and permutes the buffered amplitude bits to reduce energy variance in the encoded QAM signal. NLM interleaver 1145 may reassemble distribution-matched codewords or assign consecutive bits to amplitude lanes according to a lane-shifting sequence, and may operate in single or dual polarization modes. The permuted sign and amplitude bits from the NLM interleaver 1145 are provided to mapper 1140, which assigns the bits to the appropriate I/Q components for QAM symbol generation and transmission.

In receiver section 1150, a received signal is first processed by soft demapper 1160, which extracts soft information for the sign and amplitude bits from the received QAM symbols. The output of soft demapper 1160 is provided to NLM de-interleaver 1155, which buffers the amplitude bits and reverses the permutation applied by the NLM interleaver 1145 at the transmitter, thereby restoring the order of the amplitude bits. The output of NLM de-interleaver 1155 is processed by parity de-interleaver 1162, which reverses the permutation applied by parity interleaver 1133. Error decorrelator 1163 further processes the data to restore the original error characteristics prior to FEC decoding. The output is then processed by SD-FEC decoder 1170, which performs error correction using the restored bit sequence. Inverse error decorrelator 1173 and a pre-FEC de-interleaver 1175 further process the data to reconstruct the original order of the DM-encoded bits. DM decoder 1180 recovers the original amplitude data, and merger 1190 combines the recovered amplitude and sign data to generate recovered signal 1195.

The architecture shown in FIG. 11 includes multiple interleaving and de-interleaving operations and decorrelation operations, including pre-FEC interleaving, payload error decorrelation, parity interleaving, and NLM interleaving, with corresponding de-interleaving and decorrelation stages in the receiver path. Including a payload error decorrelator and parity interleaver provides enhanced error dispersion and supports advanced FEC schemes such as staircase codes.

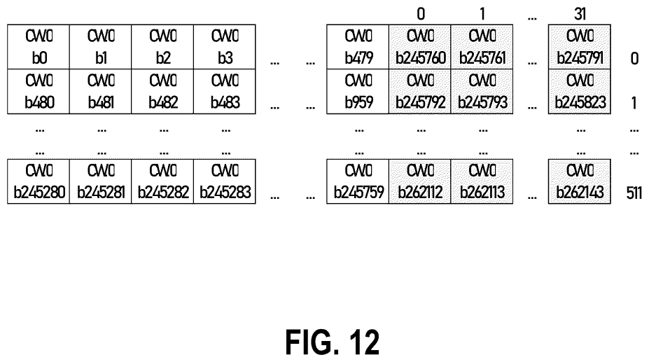

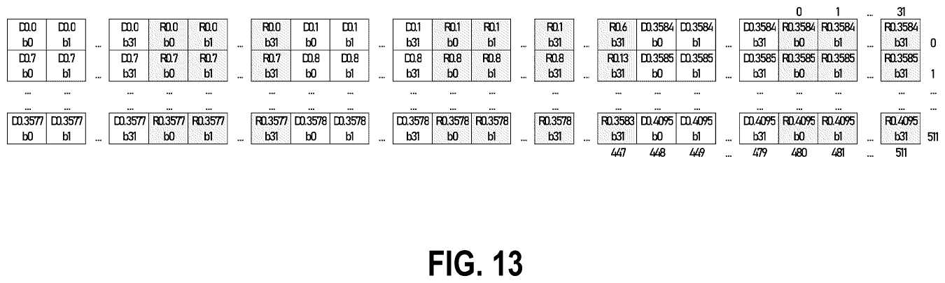

FIG. 12 illustrates an example FEC encoder output for the encoder of FIG. 11, according to some embodiments of the disclosure. FIG. 13 illustrates an example output codeword for the encoder of FIG. 11, according to some embodiments of the disclosure.

As noted above, FEC encoder 1130 may be a staircase encoder with a codeword length of N=512×512 bits and a dimension of K=512×480, resulting in a 6.67% FEC overhead. In FIG. 12, codewords are labeled as CW[i]=(CW[i].b[0], CW[i].b[1], CW[i].b[2], . . . , CW[i].b[262143]), where i refers to the ith transmitted codeword, CW[i].b[0] refers to the first bit of the codeword, CW[i].b[1] refers to the second transmitted bit, and so on.

FEC encoder 1130 works in conjunction with payload error decorrelator 1127 for the codeword payload (512×480 data bits) and a parity error decorrelator (512×32 parity bits), e.g., parity interleaver 1133. The payload error decorrelator modifies the encoder input and affects the generation of the resulting parity bits. However, the payload bits are transmitted without being interleaved by it. Consequently, pre-FEC interleaver 1125 operates as follows: the first 512×480 bits consist of a sequence of one DM word (DM[i][j]: 32-bit words in this example) and a random word (RW[i][j]), each 32 bits in length. The last 512×32 FEC encoder payload bits consist of DM words. After FEC encoder 1130 generates the parity bits, there is an equal number of amplitude and sign bits. These last 512×32 payload bits, composed purely of 32-bit DM words, are buffered so that when the 512×32 FEC parity bits are available, they can be interleaved in pairs of DM words and 32-bit random words (from parity bits).

In this case, the NLM interleaver 1145 buffers 16 consecutive DM words and 16 consecutive 32-bit random words and performs any of the modes (single lane, single polarization, dual polarization) described above, with the simplification that there is data from only a single codeword.

### Example RCS Architecture With NLM Interleaving and Parallel Paths

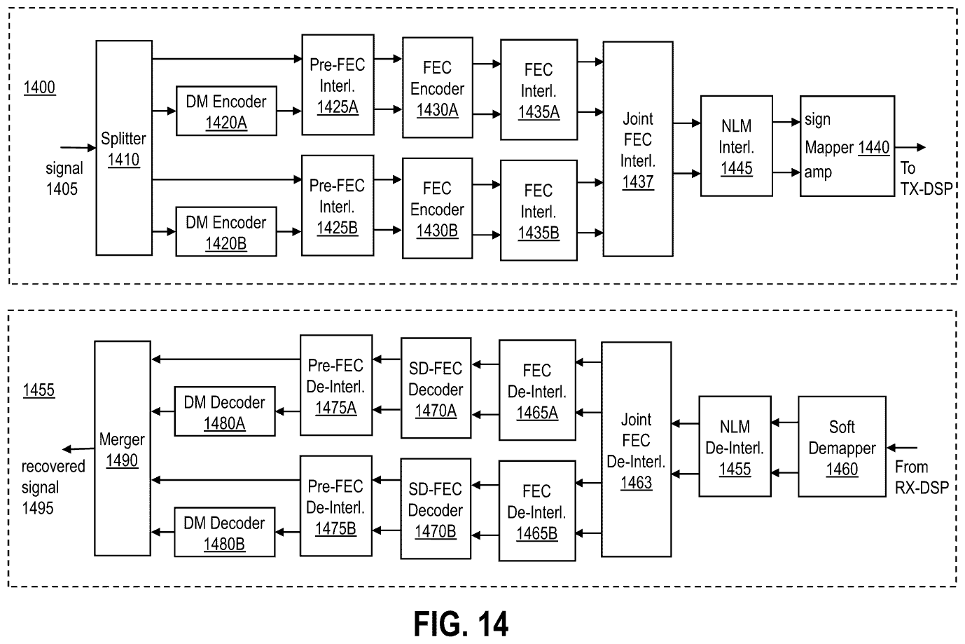

In other examples, the FEC encoder may have semi-infinite length codewords, such as a braided code. In such embodiments, the transmitter section and receiver section may each include two parallel encoding paths (in the transmitter) and two parallel decoding paths (in the receiver), as illustrated in FIG. 14.

FIG. 14 illustrates block diagrams of a transmitter section 1400 and a receiver section 1450 for encoding and decoding signals in an optical communication system, according to embodiments of the disclosure. The architecture shown in FIG. 14 supports advanced FEC schemes utilizing semi-infinite codewords, tiled payload and parity structures, and joint interleaving operations.

In the example of FIG. 14, FEC encoders 1430 may employ a semi-infinite codeword composed of FEC blocks, where each block includes 16×256 bits (4096 bits per block). Each block contains 14×256 bits of payload and 2×256 bits of parity, resulting in a 14.29% FEC overhead. The FEC blocks are further divided into 16×16-bit sub-blocks (256-bit sub-blocks), referred to as tiles. There are two parallel DM encoding and FEC encoding paths on the transmit path, and two parallel DM decoding and FEC decoding paths on the receive path. Specifically, each encoding path includes DM encoder 1420A or 1420B, pre-FEC interleaver 1425A or 1425B, FEC encoder 1430A or 1430B, and FEC interleaver 1435A or 1435B, with the “A” components along one path, and the “B” components on a parallel path. The outputs of the FEC interleavers 1435A and 1435B are provided to joint FEC interleaver 1437, which performs an interleaving operation on signals from both paths. The decoding side includes a joint FEC de-interleaver 1463 to reverse the operation of the joint FEC interleaver 1437, FEC de-interleavers 1465A and 1465B, SD-FEC decoders 1470A and 1470B, pre-FEC de-interleavers 1475A and 1475B, and DM decoders 1480A and 1480B, the “A” components along one path, and the “B” components on a parallel path.

In an example, the DM word length may be selected to be 256 bits. The codeword may be organized as an array of tiles with 2 rows and 8 columns, corresponding to 32 rows of bits and 128 columns of bits. Tile columns 0 through 6 contain payload bits, while tile column 7 contains parity bits.

In each transmit path, pre-FEC interleavers 1425A and 1425B distribute the DM words among the tiles. In this example, each DM word is 256 bits in length. Pre-FEC interleavers 1425A and 1425B may assemble the DM words so that each word is contained within a single FEC-block tile. Additionally, even-numbered tile columns contain tiles with DM words, while odd-numbered tile columns contain tiles with 256-bit random words. The parity tiles (tile column 7) are also considered to have random content. In this context, random words refer to bits that come directly from the input without being encoded by the distribution matching encoder, as in previous examples.

FEC interleavers 1435A and 1435B mix DM words with random words. The outputs of the DM FEC interleavers 1435A and 1435B are arranged in 2×8 tile matrices, similar to output blocks of the FEC encoders 1430A and 1430B. The output tiles may be created by round-robin interleaving the 16-bit rows of an even and an odd tile. For example, output tile 0 row 0 corresponds to input tile 0 row 0; output tile 0 row 1 corresponds to input tile 1 row 0; output tile 0 row 2 corresponds to input tile 0 row 1; output tile 0 row 3 corresponds to input tile 1 row 1, and so on. This arrangement ensures that, after the interleaving steps at the FEC interleavers 1435A and 1435B and the joint FEC interleaver 1440, the NLM buffer used by NLM interleaver 1445 is smaller than the memory required for the joint FEC interleaver 1440 alone.

Joint FEC interleaver 1440 may buffer a matrix of 32×8 tiles, with even-numbered tiles coming from FEC encoder 1430A and odd-numbered tiles from FEC encoder 1430B. The tile array may be divided into two sub-arrays by the middle row: rows 0 to 15 are assigned to the first sub-array, and rows 16 to 31 to the second sub-array. The output sequence for joint FEC interleaver 1440 is generated as follows: read 8 bits from the even-numbered tile columns of sub-array 0, then read 8 bits from the odd-numbered tile columns of sub-array 0, followed by 8 bits from the even-numbered tile columns of sub-array 1, and finally 8 bits from the odd-numbered tile columns of sub-array 1. This process is repeated until all the bits of the first column are read. The same procedure is then applied to the subsequent columns until all bits are read.

With the combined operation of pre-FEC interleavers 1425A and 1425B, DM FEC interleavers 1435A and 1435B, and joint FEC interleaver 1440, the NLM interleaver 1445 is designed to buffer 256×2×32 bits (16,384 bits) of the output of the joint FEC interleaver 1440. The resulting buffer content may contain 32 pairs of DM words and random words, evenly split between FEC encoder 1430A and FEC encoder 1430B. The buffer data can be divided into 4 sub-groups, each containing 4 DM word plus random word pairs from FEC encoder 1430A and 4 DM word plus random word pairs from FEC encoder 1430B. The interleaving procedures described above (e.g., single lane mode, single polarization mode, or dual polarization mode) can then be applied to each sub-group, adjusting the number of codewords from 4 to 2, and the DM word and random word length from 64 to 256 bits.

### Example Bit Mapping for Interleaver

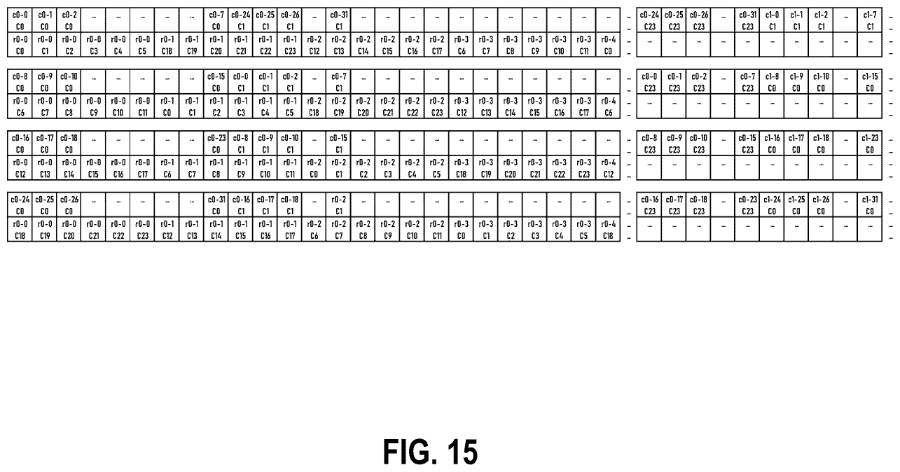

FIG. 15 illustrates an example bit mapping diagram for a 16QAM implementation with 24 codewords and 32-bit DM words, according to some embodiments of the disclosure. In this example, each codeword is assigned a unique numerical identifier C0-C23. The bits from each codeword are distributed across multiple amplitude lanes according to a predetermined lane-shifting sequence.

The output pattern is arranged in four blocks, each block containing two rows. Within each block, the upper row corresponds to amplitude bits for HI (top row of uppermost block), HQ (top row of second block), VI (top row of third block), and VQ (top row of bottom block). The lower row of each block corresponds to sign bits for HI, HQ, VI, or VQ. Within each block, each column corresponds to a bit position within the transmitted sequence. The bits are labeled with their respective codeword number (between C0 and C23). The amplitude bits, which are the DM-controlled bits, are further labeled with the DM block (e.g., c0, c1). The sign bits include an unnumbered letter (a, b, c, d) indicating how the 24 codewords are assembled into 4 groups that are split into 4 sign bits. Each 24 random bit pack (used for signs) are mapped to sign bits, with the mapping shifted from block to block. The mapping is performed such that consecutive bits from each codeword are not concentrated within a single amplitude lane, but are instead interleaved across several lanes. This arrangement ensures that bits from different codewords are uniformly distributed throughout the transmission (e.g., across the amplitude lanes), minimizing the likelihood of energy concentration in any single lane or time interval.

The interleaving operation depicted in FIG. 15 may be implemented by an NLM interleaver, e.g., any of the NLM interleavers described above. The NLM interleaver buffers the output of the encoding stages and permutes the bits according to the lane-shifting sequence shown in FIG. 15. In some embodiments, the mapping may be extended to support dual polarization transmission, wherein groups of bits are assigned to amplitude lanes associated with different polarizations. For example, the NLM interleaver may operate in a dual polarization mode that distributes groups of bits from each distribution-matched word across amplitude lanes of different polarizations, or in the single polarization mode described with respect to FIG. 10. This mapping strategy supports robust error correction and mitigates the impact of optical channel non-linearities by reducing energy variance in the transmitted signal. FIG. 15 illustrates one example; more generally, the NLM interleaver may interleave bits from other numbers of codewords, e.g., at least 24 different codewords.

### Select Examples

Example 1 provides a method for reducing non-linear effects in an encoded quadrature amplitude modulation (QAM) signal, the method including splitting a sequence of bits into a first sequence and a second sequence; encoding the second sequence using a distribution matching encoder; performing a first interleaving operation on the first sequence and the encoded second sequence; encoding an output of the first interleaving operation using a forward error correction (FEC) encoder; performing a second interleaving operation based on signals output by the FEC encoder; and performing a third interleaving operation based on signals output by the second interleaving operation, where the second interleaving operation outputs an amplitude signal and a sign signal, and the third interleaving operation reduces energy variance in the amplitude signal.

Example 2 provides the method of example 1, where encoding the output of the first interleaving operation using the FEC encoder includes generating parity bits based on a first interleaved signal and a second interleaved signal; and adding the parity bits to the first interleaved signal.

Example 3 provides the method of example 1 or 2, where the encoded QAM signal is output over an optical channel.

Example 4 provides the method of any of examples 1-3, where the third interleaving operation further includes buffering the amplitude signal output by the second interleaving operation; and permuting the buffered amplitude signal to reduce the energy variance.

Example 5 provides the method of example 4, where encoding the second sequence using the distribution matching encoder generates a plurality of distribution-matched codewords, and permuting the buffered amplitude signal to reduce the energy variance includes reassembling the distribution-matched codewords.

Example 6 provides the method of example 5, where the FEC encoder interleaves bits of different ones of the plurality of distribution-matched codewords.

Example 7 provides the method of any of examples 1-6, where the FEC encoder includes a staircase encoder configured to generate codewords having a payload portion and a parity portion, and the third interleaving operation buffers a plurality of distribution-matched words generated from the second sequence and a plurality of random words generated from the first sequence, where the random words are further derived from the parity portion.

Example 8 provides the method of example 7, where the staircase encoder operates in conjunction with a payload error decorrelator and a parity interleaver, and where the payload error decorrelator modifies an input to the staircase encoder without interleaving payload bits.

Example 9 provides the method of any of examples 1-6, where the FEC encoder includes a semi-infinite codeword encoder configured to generate a plurality of FEC blocks, each block including a payload portion and a parity portion arranged in tiles.

Example 10 provides the method of example 9, where the third interleaving operation includes buffering a set of distribution-matched words and random words corresponding to multiple tiles from different FEC blocks, and interleaving the buffered words across amplitude lanes.

Example 11 provides the method of any of examples 1-6, where the FEC encoder generates a plurality of codewords, and the second interleaving operation interleaves bits from at least twenty-four different codewords.

Example 12 provides the method of example 11, where the third interleaving operation includes assigning consecutive bits of each distribution-matched word to amplitude lanes according to a lane-shifting sequence that uniformly distributes bits across the amplitude lanes.

Example 13 provides the method of example 12, where the third interleaving operation is configured to operate in a dual polarization mode that distributes groups of bits from each distribution-matched word across amplitude lanes of different polarizations.

Example 14 provides an encoding device for reducing non-linear effects in an encoded quadrature amplitude modulation (QAM) signal, the encoding device including a forward error correction (FEC) encoder; a distribution matching encoder, where the FEC encoder and the distribution matching encoder are arranged in a reverse concatenation scheme in which the distribution matching encoder is configured to operate on an input data stream before the FEC encoder; a first interleaver following the FEC encoder, where the first interleaver interleaves distribution-matched amplitude bits; and a non-linear mitigation (NLM) interleaver following the FEC encoder, the NLM interleaver configured to: buffer amplitude bits output by the first interleaver; and permute the buffered amplitude bits to reduce energy variance in the encoded QAM signal.

Example 15 provides the encoding device of example 14, further including a second interleaver between the distribution matching encoder, and the FEC encoder configured to interleave codewords output by the distribution matching encoder.

Example 16 provides the encoding device of example 14 or 15, where the distribution matching encoder is configured to generate a plurality of distribution-matched codewords, and the NLM interleaver is configured to reassemble the distribution-matched codewords before mapping the distribution-matched codewords to amplitude lanes.

Example 17 provides the encoding device of any of examples 14-16, where the NLM interleaver is configured to operate in a single polarization mode that assigns even and odd bits of each distribution-matched word to in-phase and quadrature amplitude lanes of a single polarization.

Example 18 provides the encoding device of any of examples 14-17, where the NLM interleaver is configured to operate in a dual polarization mode that distributes groups of bits from a plurality of distribution-matched words across amplitude lanes of different polarizations according to a lane-shifting sequence.

Example 19 provides the encoding device of example 14 or 15, where the FEC encoder is configured to process a plurality of codewords, and the first interleaver is configured to interleave bits from at least twenty-four different codewords.

Example 20 provides the encoding device of example 19, where the NLM interleaver is configured to assign consecutive bits of each distribution-matched word to amplitude lanes according to a lane-shifting sequence that uniformly distributes bits across the amplitude lanes.

Example 21 provides the encoding device of example 19 or 20, where the NLM interleaver is configured to operate in a dual polarization mode that distributes groups of bits from each distribution-matched word across amplitude lanes of different polarizations.

Example 22 provides the encoding device of example 14 or 15, further including a payload error decorrelator between the distribution matching encoder and the FEC encoder, the payload error decorrelator configured to modify an input to the FEC encoder prior to generation of parity bits.

Example 23 provides the encoding device of example 22, further including a parity error interleaver between the FEC encoder and the NLM interleaver, the parity error interleaver configured to interleave parity bits generated by the FEC encoder.

Example 24 provides the encoding device of example 22 or 23, where the FEC encoder is a staircase encoder.

Example 25 provides the encoding device of example 14 or 15, where the FEC encoder and the distribution matching encoder are arranged along a first path, and the device further includes a second FEC encoder and a second distribution matching encoder arranged along a second path parallel to the first path.

Example 26 provides the encoding device of example 25, where the first path includes a first post-FEC interleaver following the FEC encoder, the second path includes a second post-FEC interleaver following the second FEC encoder, and the first interleaver receives an output of the first post-FEC interleaver and the second post-FEC interleaver.

Example 27 provides a decoding device for decoding an encoded quadrature amplitude modulation (QAM) signal with reduced non-linear effects, the device including a demapper configured to output sign bits and amplitude bits from a received QAM signal; a non-linear mitigation (NLM) de-interleaver following the demapper, the NLM de-interleaver configured to: buffer amplitude bits output by the demapper; and permute the buffered amplitude bits based on an interleaving to reduce non-linear effects performed at an encoding device; a forward error correction (FEC) decoder following the NLM interleaver; and a distribution matching decoder following the FEC decoder.

Example 28 provides the decoding device of example 27, further including a FEC de-interleaver between the NLM de-interleaver and the FEC decoder.

### Variations and Other Notes

The detailed description, such as the “Select examples” section, provides various examples of the embodiments disclosed herein.

As used herein, the term “coupled to” or “coupled with” refers to a relationship between electronic components or circuit elements wherein the components are in electronic communication with one another and capable of transmitting and/or receiving electrical signals between them. The term “coupled to” does not require a direct physical or electrical connection between the coupled components. Rather, “coupled to” can encompass arrangements where the components are connected through one or more intervening elements, components, circuits, or transmission paths. For example, a first component may be “coupled to” a second component through intermediate components such as resistors, capacitors, inductors, transistors, logic gates, buses, transformers, or other electronic components, or through intermediate transmission paths, while still maintaining the capability for electronic communication between the first and second components.

The above description of illustrated implementations of the disclosure, including what is described in the Abstract, is not intended to be exhaustive or to limit the disclosure to the precise forms disclosed. While specific implementations of, and examples for, the disclosure are described herein for illustrative purposes, various equivalent modifications are possible within the scope of the disclosure, as those skilled in the relevant art will recognize. These modifications may be made to the disclosure in light of the above detailed description.

For purposes of explanation, specific numbers, materials and configurations are set forth in order to provide a thorough understanding of the illustrative implementations. However, it will be apparent to one skilled in the art that the present disclosure may be practiced without the specific details and/or that the present disclosure may be practiced with only some of the described aspects. In other instances, well known features are omitted or simplified in order not to obscure the illustrative implementations.

Further, references are made to the accompanying drawings that form a part hereof, and in which are shown, by way of illustration, embodiments that may be practiced. It is to be understood that other embodiments may be utilized, and structural or logical changes may be made without departing from the scope of the present disclosure. Therefore, the following detailed description is not to be taken in a limiting sense.

Various operations may be described as multiple discrete actions or operations in turn, in a manner that is most helpful in understanding the disclosed subject matter. However, the order of description should not be construed as to imply that these operations are necessarily order dependent. In particular, these operations may not be performed in the order of presentation. Operations described may be performed in a different order from the described embodiment. Various additional operations may be performed or described operations may be omitted in additional embodiments.

For the purposes of the present disclosure, the phrase “A or B” or the phrase “A and/or B” means (A), (B), or (A and B). For the purposes of the present disclosure, the phrase “A, B, or C” or the phrase “A, B, and/or C” means (A), (B), (C), (A and B), (A and C), (B and C), or (A, B, and C). The term “between,” when used with reference to measurement ranges, is inclusive of the ends of the measurement ranges.

The description uses the phrases “in an embodiment” or “in embodiments,” which may each refer to one or more of the same or different embodiments. The terms “comprising,” “including,” “having,” and the like, as used with respect to embodiments of the present disclosure, are synonymous. The disclosure may use perspective-based descriptions such as “above,” “below,” “top,” “bottom,” and “side” to explain various features of the drawings, but these terms are simply for ease of discussion, and do not imply a desired or required orientation. The accompanying drawings are not necessarily drawn to scale. Unless otherwise specified, the use of the ordinal adjectives “first,” “second,” and “third,” etc., to describe a common object, merely indicates that different instances of like objects are being referred to and are not intended to imply that the objects so described must be in a given sequence, either temporally, spatially, in ranking or in any other manner.

In the following detailed description, various aspects of the illustrative implementations will be described using terms commonly employed by those skilled in the art to convey the substance of their work to others skilled in the art.

The terms “substantially,” “close,” “approximately,” “near,” and “about,” generally refer to being within +/−20% of a target value as described herein or as known in the art. Similarly, terms indicating orientation of various elements, e.g., “coplanar,” “perpendicular,” “orthogonal,” “parallel,” or any other angle between the elements, generally refer to being within +/−5-20% of a target value as described herein or as known in the art.

In addition, the terms “comprise,” “comprising,” “include,” “including,” “have,” “having” or any other variation thereof, are intended to cover a non-exclusive inclusion. For example, a method, process, or device, that comprises a list of elements is not necessarily limited to only those elements but may include other elements not expressly listed or inherent to such method, process, or device. Also, the term “or” refers to an inclusive “or” and not to an exclusive “or.”

The systems, methods and devices of this disclosure each have several innovative aspects, no single one of which is solely responsible for all desirable attributes disclosed herein. Details of one or more implementations of the subject matter described in this specification are set forth in the description and the accompanying drawings.

1. A method for reducing non-linear effects in an encoded quadrature amplitude modulation (QAM) signal, the method comprising:
splitting a sequence of bits into a first sequence and a second sequence;
encoding the second sequence using a distribution matching encoder;
performing a first interleaving operation on the first sequence and the encoded second sequence;
encoding an output of the first interleaving operation using a forward error correction (FEC) encoder;
performing a second interleaving operation based on signals output by the FEC encoder; and
performing a third interleaving operation based on signals output by the second interleaving operation, wherein the second interleaving operation outputs an amplitude signal and a sign signal, and the third interleaving operation reduces energy variance in the amplitude signal.

2. The method of claim 1, wherein encoding the output of the first interleaving operation using the FEC encoder comprises:
generating parity bits based on a first interleaved signal and a second interleaved signal; and
adding the parity bits to the first interleaved signal.

3. The method of claim 1, wherein the encoded QAM signal is output over an optical channel.

4. The method of claim 1, wherein the third interleaving operation further comprises:
buffering the amplitude signal output by the second interleaving operation; and
permuting the buffered amplitude signal to reduce the energy variance.

5. The method of claim 4, wherein encoding the second sequence using the distribution matching encoder generates a plurality of distribution-matched codewords, and permuting the buffered amplitude signal to reduce the energy variance comprises reassembling the distribution-matched codewords.

6. The method of claim 5, wherein the FEC encoder interleaves bits of different ones of the plurality of distribution-matched codewords.

7. The method of claim 1, wherein the FEC encoder comprises a staircase encoder configured to generate codewords having a payload portion and a parity portion, and the third interleaving operation buffers a plurality of distribution-matched words generated from the second sequence and a plurality of random words generated from the first sequence, wherein the random words are further derived from the parity portion.

8. The method of claim 7, wherein the staircase encoder operates in conjunction with a payload error decorrelator and a parity interleaver, and wherein the payload error decorrelator modifies an input to the staircase encoder without interleaving payload bits.

9. The method of claim 1, wherein the FEC encoder comprises a semi-infinite codeword encoder configured to generate a plurality of FEC blocks, each block including a payload portion and a parity portion arranged in tiles.

10. The method of claim 9, wherein the third interleaving operation comprises buffering a set of distribution-matched words and random words corresponding to multiple tiles from different FEC blocks, and interleaving the buffered words across amplitude lanes.

11. The method of claim 1, wherein the FEC encoder generates a plurality of codewords, and the second interleaving operation interleaves bits from at least twenty-four different codewords.

12. The method of claim 11, wherein the third interleaving operation comprises assigning consecutive bits of each distribution-matched word to amplitude lanes according to a lane-shifting sequence that uniformly distributes bits across the amplitude lanes.

13. The method of claim 12, wherein the third interleaving operation is configured to operate in a dual polarization mode that distributes groups of bits from each distribution-matched word across amplitude lanes of different polarizations.

14. An encoding device for reducing non-linear effects in an encoded quadrature amplitude modulation (QAM) signal, the encoding device comprising:
a forward error correction (FEC) encoder;
a distribution matching encoder, wherein the FEC encoder and the distribution matching encoder are arranged in a reverse concatenation scheme in which the distribution matching encoder is configured to operate on an input data stream before the FEC encoder;
a first interleaver following the FEC encoder, wherein the first interleaver interleaves distribution-matched amplitude bits; and
a non-linear mitigation (NLM) interleaver following the FEC encoder, the NLM interleaver configured to:
buffer amplitude bits output by the first interleaver; and
permute the buffered amplitude bits to reduce energy variance in the encoded QAM signal.

15. The encoding device of claim 14, further comprising a second interleaver between the distribution matching encoder and the FEC encoder configured to interleave codewords output by the distribution matching encoder.

16. The encoding device of claim 14, wherein the distribution matching encoder is configured to generate a plurality of distribution-matched codewords, and the NLM interleaver is configured to reassemble the distribution-matched codewords before mapping the distribution-matched codewords to amplitude lanes.

17. The encoding device of claim 14, wherein the FEC encoder is configured to process a plurality of codewords, and the first interleaver is configured to interleave bits from at least twenty-four different codewords.

18. The encoding device of claim 17, wherein the NLM interleaver is configured to assign consecutive bits of each distribution-matched word to amplitude lanes according to a lane-shifting sequence that uniformly distributes bits across the amplitude lanes.

19. A decoding device for decoding an encoded quadrature amplitude modulation (QAM) signal with reduced non-linear effects, the device comprising:
a demapper configured to output sign bits and amplitude bits from a received QAM signal;
a non-linear mitigation (NLM) de-interleaver following the demapper, the NLM de-interleaver configured to:
buffer amplitude bits output by the demapper; and
permute the buffered amplitude bits based on an interleaving to reduce non-linear effects performed at an encoding device;
a forward error correction (FEC) decoder following the NLM interleaver; and
a distribution matching decoder following the FEC decoder.

20. The decoding device of claim 19, further comprising a FEC de-interleaver between the NLM de-interleaver and the FEC decoder.
